(19) United States
(12) Patent Application Publication
(10) Pub. No.: US 2025/0124599 A1
(43) Pub. Date: Apr. 17, 2025

(54) AUTOMATIC CALIBRATION OF AN EXAMINATION TOOL

(71) Applicant: Applied Materials Israel Ltd., Rehovot (IL)

(72) Inventors: Dimitry SHCERB, Yavne (IL); Vivekanand MISHRA, Bengaluru (IN); Vignesh Babu PULIADI JAGADEESAN, Bengaluru (IN); Roman ABEZGAUZ, Mazkeret Batya (IL); Tomer FARHI, Rishon Lezion (IL); Sachin DANGAYACH, San Jose, CA (US); Victor Rotion D'SOUZA, San Jose, CA (US)

(21) Appl. No.: 18/485,308

(22) Filed: Oct. 11, 2023

(51) Int. Cl. G06T 7/80; G06T 7/70

(52) U.S. Cl. CPC G06T 7/80; G06T 7/70; G06T 2207/30244

(57) ABSTRACT

There are provided systems and methods of calibration of an examination tool comprising at least one given optical device associated with a given moveable element, at least one of a position or an orientation of the given moveable element having to be calibrated, the system being configured to obtain a data set comprising values for one or more given parameters characterizing light transmitted by the at least one given optical device for different values of the position or of the orientation of the given moveable element, one or more required values for the one or more given parameters, and use the data set and the one or more required values to determine data informative of at least one of a calibrated position or a calibrated orientation of the given moveable element, enabling the one or more parameters to have values matching the one or more required values.

### TECHNICAL FIELD

The presently disclosed subject matter relates, in general, to the field of examination of a specimen, and more specifically, to automating the calibration of an examination tool.

### BACKGROUND

Current demands for high density and performance associated with ultra largescale integration of fabricated devices require submicron features, increased transistor and circuit speeds, and improved reliability. Such demands require formation of device features with high precision and uniformity, which, in turn, necessitates careful monitoring of the fabrication process, including automated examination of the devices while they are still in the form of semiconductor wafers.

Examination processes are used at various steps during semiconductor fabrication to measure dimensions of the specimens (metrology), and/or to detect and classify defects on specimens (e.g., Automatic Defect Classification (ADC), Automatic Defect Review (ADR), etc.).

The examination tool(s) used during the examination processes need to be calibrated. There is a need to propose new methods and systems enabling calibration of the examination tool(s).

### GENERAL DESCRIPTION

In accordance with certain aspects of the presently disclosed subject matter, there is provided a system usable to calibrate an examination tool, the examination tool comprising a light source producing an illuminating beam transmitted along a light path, and a plurality of optical devices located on said light path, at least one given optical device of the plurality of optical devices being associated with a given moveable element, at least one of a position or an orientation of the given moveable element having to be calibrated, the system comprising at least one processing circuitry configured to obtain a data set comprising values for one or more given parameters characterizing light transmitted by the at least one given optical device for different values of the position or of the orientation of the given moveable element, obtain one or more required values for the one or more given parameters, and use the data set and the one or more required values to determine data informative of at least one of a calibrated position or a calibrated orientation of the given moveable element enabling the one or more parameters characterizing light transmitted by the at least one given optical device to have values matching the one or more required values according to a matching criterion.

According to some embodiments, the system is configured to use the data set, the one or more required values and a Bayesian optimizer to determine data informative of at least one of a calibrated position or a calibrated orientation of the given moveable element.

According to some embodiments, the system is configured to determine the data informative of at least one of a calibrated position or a calibrated orientation of the given moveable element after a plurality of iterations, wherein, the system is configured, for at least one given iteration of the plurality of iterations, to use a data set comprising values for one or more given parameters characterizing light transmitted by the at least one given optical device for one or more positions or one or more orientations of the given moveable element, wherein at least part of said values correspond to one or more positions or one or more orientations of the at least one given optical device, determined at one or more previous iterations of the plurality of iterations.

According to some embodiments, the system is configured to determine the data informative of at least one of a calibrated position or a calibrated orientation of the given moveable element after a plurality of iterations, wherein, for at least one given iteration of the plurality of iterations, the system is configured to use values for one or more given parameters characterizing light transmitted by the at least one given optical device for different values of the position or of the orientation of the given moveable element to determine data informative of at least one of an updated position or an updated orientation of the given moveable element, obtain one or more updated values for one or more given parameters characterizing light transmitted by the at least one given optical device at said updated position or at said updated orientation, and use said one or more updated values at a next iteration of the plurality of iterations.

According to some embodiments, the system is configured to feed the data set and the one or more required values to an optimization algorithm to determine data informative of at least one of a calibrated position or a calibrated orientation of the given moveable element, wherein the optimization algorithm is operable to determine the data informative of at least one of a calibrated position or a calibrated orientation of the given moveable element without requiring prior training.

According to some embodiments, the system is configured to use the data set, the one or more required values and an optimization algorithm to determine data informative of at least one of a calibrated position or a calibrated orientation of the given moveable element, wherein a cost function used by the optimization algorithm is selected to be convex.

According to some embodiments, the system is configured to, responsive to a failure of determination of data informative of at least one of a calibrated position or a calibrated orientation of the given moveable element enabling the one or more given parameters characterizing light transmitted by the at least one given optical device, to have values matching the one or more required values according to the matching criterion, determine that the at least one given optical device is faulty, or that the examination tool is faulty.

According to some embodiments, at least one, or more, of the one or more given parameters is informative of a quality of a light transmitted by the at least one given optical device.

According to some embodiments, after the at least one given optical device has been calibrated at least once using the data set, the system is configured to obtain a current uncalibrated position value or a current uncalibrated orientation value of the given moveable element of the at least one given optical device, obtain one or more required values for the one or more given parameters, obtain one or more current values for one or more given parameters characterizing light transmitted by the at least one given optical device, and use the data set, the one or more current values for the one or more given parameters, and at least one of the current uncalibrated position value or the current uncalibrated orientation value to determine data informative of at least one of a calibrated position or a calibrated orientation of the given moveable element, enabling the one or more parameters characterizing light transmitted by the at least one given optical device to have values matching the one or more required values according to a matching criterion.

According to some embodiments, the one or more processing circuitries are configured to communicate with the examination tool to obtain the one or more values for the one or more given parameters.

According to some embodiments, the given moveable element is associated with at least one given actuator enabling moving the given moveable element, wherein the at least one processing circuitry is configured to generate a command enabling the at least one given actuator to displace the given moveable element to the calibrated position or to the calibrated orientation.

According to some embodiments, the given moveable element is associated with at least one given actuator enabling moving the given moveable element, wherein the at least one processing circuitry implements an interface enabling transmitting the command to the examination tool, wherein the command instructs the at least one given actuator to displace the given moveable element to the calibrated position or to the calibrated orientation.

According to some embodiments, each given optical device of a set of optical devices of the examination tool is associated with a given moveable element of a set of moveable elements, and at least one of a position or an orientation of each given moveable element of the set of moveable elements has to be calibrated, wherein the at least one processing circuitry is configured, for each given optical device of the set optical devices, to obtain one or more given values for one or more given parameters characterizing light transmitted by said each given optical device for one or more values of the position or of the orientation of the given moveable element of said each given optical device, thereby obtaining a data set informative of the set of optical devices, obtain one or more given required values for the one or more given parameters of each given optical device of the set of optical devices, thereby obtaining a set of required values, and use the data set and the set of required values to determine data informative of at least one of a calibrated position or a calibrated orientation of each given moveable element of the set of moveable elements, enabling the one or more given parameters characterizing light transmitted by each given optical device of the set of optical devices to have values matching the one or more given required values according to a matching criterion.

According to some embodiments, the one or more given parameters characterizing light transmitted by a first given optical device of the set of optical devices is different from at least one of the one or more given parameters characterizing light transmitted by a second given optical device of the set of optical devices.

According to some embodiments, the at least one processing circuitry is configured to determine, simultaneously, data informative of at least one of a calibrated position or a calibrated orientation of each given moveable element of the set of moveable elements, enabling the one or more given parameters characterizing light transmitted by each given optical device of the set of optical devices, to have values matching the one or more given required values according to a matching criterion.

According to some embodiments, the system is configured to obtain a data set including, for each given optical device of one or more optical devices of the examination tool, wherein said each given optical device is associated with a given moveable element, one or more values for one or more given parameters characterizing light transmitted by said each given optical device for one or more values of the position or the orientation of the given moveable element, obtain one or more given required values for the one or more given parameters of each given optical device, thereby obtaining a set of one or more required values, and use the data set and the set of one or more required values to determine data informative of at least one of a given updated position or a given updated orientation of the given moveable element of each given optical device of the one or more optical devices.

According to some embodiments, the system is configured to (1) obtain a set of one or more updated values, wherein the set of one or more updated values comprises, for each given optical device, given updated values for the one or more given parameters characterizing light transmitted by said each given optical device, wherein the given moveable element of said each given optical device of the one or more optical devices complies with said given updated position or with said given updated orientation, thereby enabling augmenting the data set with the set of one or more updated values, (2) use at least part of the data set and the set of one or more required values to determine data informative of at least one of a given updated position or a given updated orientation of the given moveable element of each given optical device of the one or more optical devices, and (3) repeat (1) and (2) until the one or more given parameters characterizing light transmitted by said each given optical device of the one or more optical devices have values matching the one or more given required values according to a matching criterion.

According to some embodiments, the at least one processing circuitry is configured to send a command to the examination tool to displace the given moveable element of said each given optical device of the one or more optical devices to the updated position or to the updated orientation.

According to some embodiments, the system is configured to obtain, for each given optical device, the one or more updated values for the one or more given parameters characterizing light transmitted by said each given optical device, following an input from an operator instructing the given moveable element of said each given optical device of the one or more optical devices to reach the updated position or the updated orientation.

In accordance with certain aspects of the presently disclosed subject matter, there is provided a method comprising, for an examination tool comprising a light source producing an illuminating beam transmitted along a light path, and a plurality of optical devices located on said light path, each given optical device of a set of optical devices of the plurality of optical devices being associated with a given moveable element, executing by at least one processing circuitry, obtaining a set of data comprising a plurality of values for one or more given parameters characterizing light transmitted by each given optical device of the set of optical devices, for a plurality of different values of the position or of the orientation of the given moveable element associated with said each given optical device, obtaining data informative of a dependency between the optical devices of the set of optical devices, and using the set of data and the data informative of the dependency to generate a predictive model informative of the set of optical devices, wherein the predictive model is usable for at least one of calibrating or simulating the examination tool.

According to some embodiments, the method comprises using the predictive model to estimate, for a given value of the position or of the orientation of a first given moveable element of a first given optical device of the set of optical devices, one or more predicted values for one or more given parameters characterizing light transmitted by at least one of the first given optical device or by a second given optical device different from the first given optical device.

In accordance with certain aspects of the presently disclosed subject matter, there is provided a non-transitory computer readable medium comprising instructions that, when executed by a computer, cause the computer to perform operations enabling calibration of an examination tool, the examination tool comprising a light source producing an illuminating beam transmitted along a light path, and a plurality of optical devices located on said light path, at least one given optical device of the plurality of optical devices being associated with a given moveable element, at least one of a position or an orientation of the given moveable element having to be calibrated, the operations comprising obtaining a data set comprising values for one or more given parameters characterizing light transmitted by the at least one given optical device for different values of the position or of the orientation of the given moveable element, obtaining one or more required values for the one or more given parameters, and using the data set and the one or more required values to determine data informative of at least one of a calibrated position or a calibrated orientation of the given moveable element, enabling the one or more parameters characterizing light transmitted by the at least one given optical device to have values matching the one or more required values according to a matching criterion.

According to some examples, the proposed solution enables automatic calibration of an examination tool.

According to some examples, the proposed solution significantly reduces the time required to calibrate an examination tool. In some examples, it can reduce calibration time by several days or even one week.

According to some examples, the proposed solution does not require human intervention to calibrate an examination tool.

According to some examples, the proposed solution is operative to simultaneously calibrate various optical devices of an examination tool.

According to some examples, the proposed solution improves accuracy of the calibration of optical devices of an examination tool.

According to some examples, the proposed solution is flexible and can adapt to different examination tools, including different types of optical devices, and/or a different number of optical devices.

According to some examples, the proposed solution reduces the number of trials required to calibrate the examination tool.

According to some examples, the proposed solution does not require previous historical data.

According to some examples, the proposed solution is scalable.

According to some examples, the proposed solution enables a calibration which is more repeatable.

According to some examples, the proposed solution does not require prior training and can be immediately deployed.

According to some examples, the proposed solution can predict the impact of the position of moveable element(s) of one or more optical devices of the examination tool on one or more parameters informative of the quality of the light transmitted by the one or more optical device(s).

According to some examples, the proposed solution enables generating a simulated examination tool simulating the behavior of the examination tool.

### BRIEF DESCRIPTION OF THE DRAWINGS

In order to understand the disclosure and to see how it may be carried out in practice, embodiments will now be described, by way of non-limiting example only, with reference to the accompanying drawings, in which:

FIG. 1 illustrates a generalized block diagram of an examination system in accordance with certain embodiments of the presently disclosed subject matter.

FIG. 2 illustrates a non-limitative example of an architecture of an examination tool depicted in FIG. 1.

FIG. 3A illustrates a generalized flow-chart of a method of calibrating at least one optical device of an examination tool.

FIG. 3B illustrates a generalized flow-chart of a method of calibrating a set of optical devices of an examination tool.

FIG. 4A illustrates a non-limitative example of required values for parameters characterizing light transmitted by optical devices of the examination tool.

FIG. 4B illustrates a non-limitative example of a data set informative of optical devices of an examination tool.

FIG. 5 illustrates a generalized flow-chart of a method of recalibrating a set of one or more optical devices of an examination tool, after a previous calibration.

FIG. 6A illustrates a generalized flow-chart of a method of calibrating a set of one or more optical devices of an examination tool.

FIG. 6B illustrates a generalized flow-chart of a method of calibrating a set of one or more optical devices of an examination tool, which involves an operator.

FIG. 6C illustrates a generalized flow-chart of a method of automatically calibrating a set of one or more optical devices of an examination tool.

FIG. 6D illustrates a generalized flow-chart of a method of recalibrating a set of one or more optical devices of an examination tool, after a previous calibration.

FIG. 7 illustrates a generalized flow-chart of a method of detecting whether the examination tool is faulty.

FIG. 8 illustrates a generalized flow-chart of a method of generating a predictive model informative of a set of optical devices of an examination tool.

FIG. 9 illustrates a non-limitative example of the predictive model which can be generated by the method of FIG. 8.

### DETAILED DESCRIPTION OF EMBODIMENTS

Prior art solutions for calibrating examination tools are time-consuming and often inefficient. Various methods and systems are described hereinafter which enable calibrating one or more examinations tools in an improved manner.

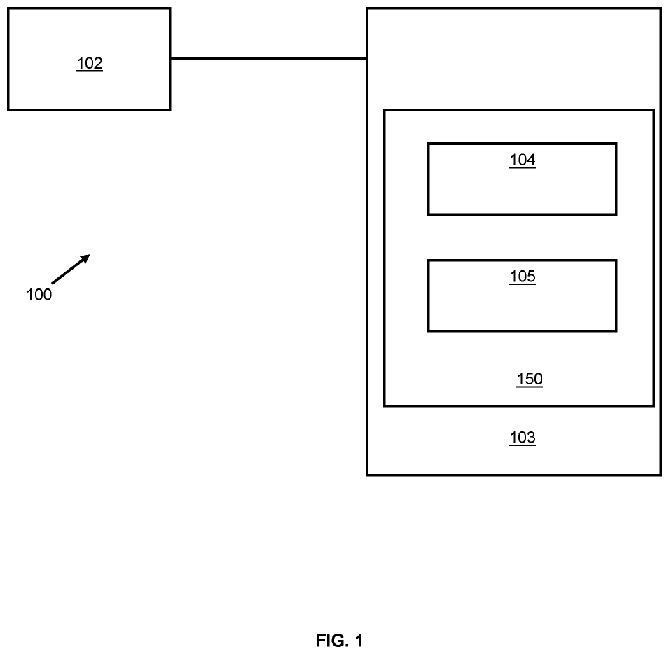

Attention is drawn to FIG. 1, which illustrates a functional block diagram of an examination system 100 in accordance with certain examples of the presently disclosed subject matter.

It is noted that the teachings of the presently disclosed subject matter are not bound by the examination system 100 described with reference to FIG. 1. Equivalent and/or modified functionality can be consolidated or divided in another manner, and can be implemented in any appropriate combination of software with firmware and/or hardware and executed on a suitable device. The examination system 100 can be a standalone network entity, or integrated, fully or partly, with other network entities. Those skilled in the art will also readily appreciate that the data repositories can be consolidated or divided in other manner; databases can be shared with other systems or be provided by other systems, including third party equipment.

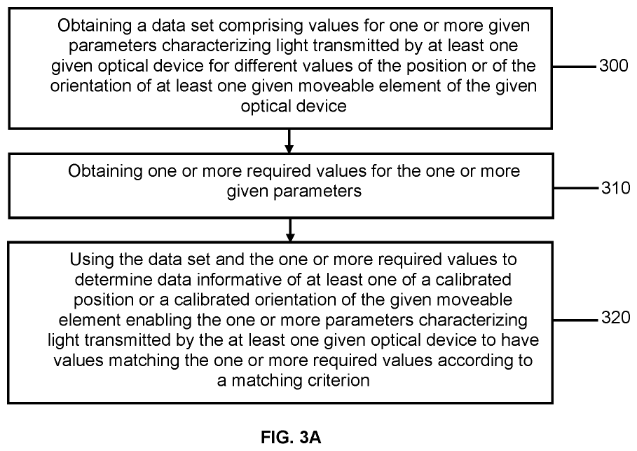

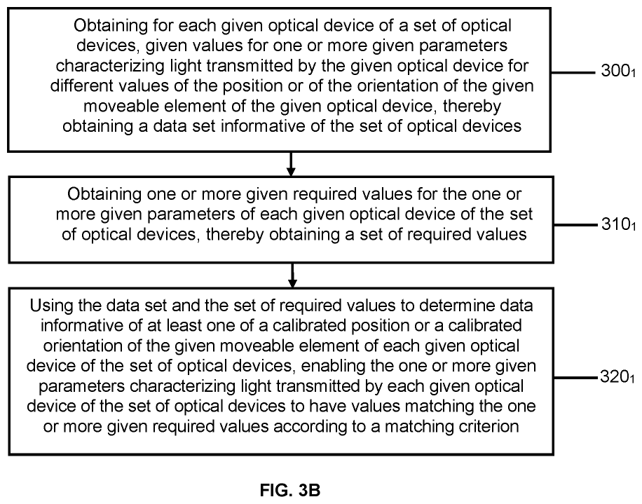

The examination system 100 comprises an examination tool 102 operative to acquire images of one or more semiconductor specimen and a computer-based system 103 including at least one (that it to say one or more) processing circuitry 150. The examination tool 102 and the system 103 are operatively coupled and can exchange data. The processing circuitry 150 is configured to provide processing necessary for performing various operations, as further detailed with reference to FIGS. 3A, 3B, 5, 6A, 6B, 6C, 6D, 7 and 8. The processing circuitry 150 can comprise one or more processors (not shown separately) and one or more memories (not shown separately). The one or more processors of processing circuitry 150 can be configured to, either separately, or in any appropriate combination, execute several functional modules in accordance with computer-readable instructions implemented on a non-transitory computer-readable memory comprised in the processing circuitry 150.

As visible in FIG. 1, the processing circuitry 150 can implement at least one optimization algorithm 105, such as (but not limited to) one or more Bayesian optimizer(s).

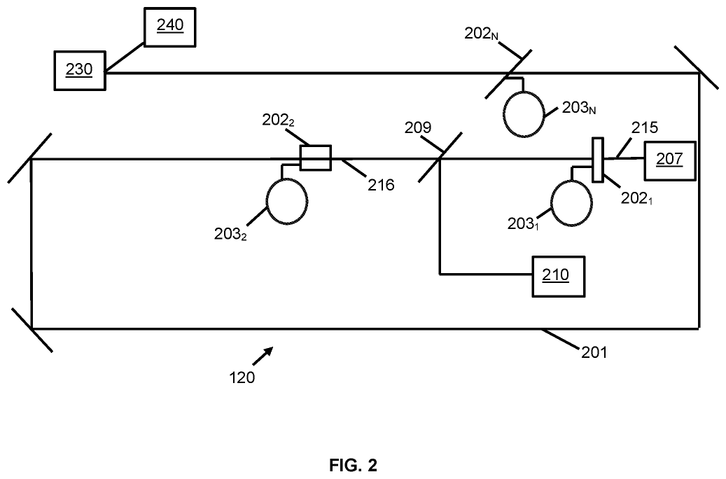

The examination tool 102 can include e.g., at least one optical inspection system, or any other type of examination tool or microscope. In some examples, the examination tool 102 is a laser based optical inspection system. In some examples, the examination tool 102 corresponds to the tool “Enlight” developed by the Applicant. FIG. 2 describes a non-limitative example of an architecture which can be used for the examination tool 102. As explained with reference to FIG. 2, the examination tool 102 can include one or more optical devices. One or more of the optical devices can be associated with a moveable element, which has to be calibrated. Note that the term “associated” includes different cases: one or more of the optical devices can include one or more moveable elements, and/or one or more of the optical devices can be itself a moveable element (that is to say that the whole optical device can be moved).

In some examples, system 103 includes an interface 104, which can be implemented by the processing circuitry 150. In some examples, the interface 104 enables transmitting command(s) generated by the processing circuitry 150 to the examination tool 102. The interface 104 can e.g., communicate with an interface (not represented) of the examination tool 102, such as, but not limited to, the ASI (Actuator Sensor Interface) of the examination tool 102. In some examples, the interface 104 can be implemented using Matlab™. This is however not limitative.

As explained hereinafter, the command(s) transmitted from system 103 to the examination tool 102 (using the interface 104) can be operative to automatically move a moveable element associated with an optical device of the examination tool 102 (without requiring intervention of a human operator). In some examples, the command(s) can be operative to automatically move several moveable elements associated with different optical devices of the examination tool 102.

In some examples, system 103 can obtain, from the examination tool 102, values (e.g. measured values) for one or more parameters characterizing light transmitted by at least one given optical device of the examination tool 102, for one or more values of the position or of the orientation of a given moveable element associated with the given optical device. Theses values can be determined by the examination tool 102 itself. In some examples, the values can be communicated by the examination tool 102 to the system 103 using the interface 104, or using another interface (not represented) of the system 103.

In some examples, the position and/or orientation of each moveable element of the examination tool 102 can be communicated from the examination tool 102 to the system 103. In other words, system 103 can automatically “read” the position and/or the orientation of the moveable element(s) of the optical device(s) of the examination tool 102, without requiring human intervention. In some examples, the position and/or orientation of each moveable element can be communicated by the examination tool 102 to the system 103 using the interface 104, or using another interface (not represented) of the system 103.

Attention is now drawn to FIG. 2, which describes a non-limitative example of an architecture that can be used in the examination tool 102. The architecture described in FIG. 2 is not limitative and a different architecture can be used (e.g., with a different number of optical devices, and/or with different types of optical devices, and/or with a different arrangement of the optical devices, etc.). Note also that FIG. 2 depicts only a portion of a possible architecture of the examination tool 102.

The examination tool 102 can include a light source 207 producing an illumination beam 215, and a scanner 120 including a plurality of optical devices 202₁, 202₂, . . . 202_{N}. Examples of optical devices include (this list is not limitative): mirrors, lenses, beam shaper(s), phase corrector(s), sampler(s), beam expander(s) (which can in particular expand and/or polarize light), beam divider(s) (which can, in particular, divide light into a plurality of beams), beam collector(s) (which can, in particular, collect a plurality of beams in order to create a unified beam).

The illumination beam 215 propagates along a light path 201 (also called optical path), on which at least some or all of the optical devices 202₁ to 202_{N} are located.

In a scanning mode of the examination tool 102, a given optical device 202; is configured to transmit light along an optical path towards another optical device 202ᵢ₊₁. For example, in a scanning mode, the optical device 202₁ is configured to transmit light towards the optical device 202₂, along optical path 216. At least some of the optical devices 202₁, 202₂, . . . 202_{N} are each associated with a different moveable element (not represented).

In some examples, the moveable element associated with a given optical device can correspond to a part of the optical device (for example, a mirror or a lens of the optical device). In some examples, the moveable element corresponds to the optical device itself (in other words, the whole given optical device itself is moveable). In order to ensure a motion of the moveable element, at least some of the optical devices 202₁, 202₂, . . . 202_{N} can be associated (or can include) an actuator (see 203₁, 203₂, . . . 203_{N}), such as an electro-mechanic actuator, a motor, etc., operatively coupled with the moveable element, in order to ensure a motion of the moveable element. Each moveable element can be displaced in translation and/or in rotation and/or according to another adapted motion.

The scanner 120 can further include a plurality of detectors (light detector(s) and/or image detector(s)). Non-limitative examples of detectors include detectors 210, 230 and 240. The detectors can be located at different locations in the examination tool 102. At least some of the detectors can be located on the optical path 201. In some examples, at least one or more of the detectors can be located on an optical path different from the optical path 201.

In some examples, at least part of the light transmitted by a given optical device can be deviated towards a detector, before the light reaches the next optical device. A non-limitative example is illustrated in FIG. 2, in which light transmitted by the optical device 202₁ can be deviated by the optical element 209 (which can correspond to a mirror or a periscope) towards the detector 210.

Attention is now drawn to FIG. 3A, which illustrates a method of calibrating one or more optical devices of the examination tool 102.

Assume that it is desired to calibrate a given optical device of the examination tool 102, associated with a given moveable element. The method of FIG. 3A includes obtaining (operation 300) a data set comprising values for one or more given parameters characterizing light transmitted by the at least one given optical device for different values of the position or of the orientation of the given moveable element.

At least part of the light transmitted by the given optical device to be calibrated is collected by at least one detector (see e.g., detectors 210, 230 or 240) of the examination tool 102. Data measured by the detector (which can correspond to a pixel intensity signal, such as a grey level signal) can be used to determine values for one or more given parameters characterizing light transmitted by the given optical device. The signal used to determine the values for the parameters can be a one-dimensional signal (measured along a first direction X or a second direction Y), or a two-dimensional signal (measured along a first direction X and a second direction Y).

Assume for example that the given optical device to be calibrated corresponds to the optical device 202₁. Light measured by the detector 230 can be used to determine values for one or more given parameters characterizing light transmitted by the optical device 202₁. Note that in this example, light transmitted by the optical device 202₁ interacts with additional optical devices (202₂ to 202_{N}) before it reaches the detector 230. This does not affect computation of the values of the parameter(s) informative of the light transmitted by the optical device 202₁. Indeed, it is possible to choose parameters which are affected only by the optical device 202₁, and not by the optical devices 202₂ to 202_{N}. Similarly, assume that it is desired to calibrate the optical device 202₂. It is possible to obtain the signal measured by the detector 230, and to use this signal to compute values for second parameters (different from the first parameters) informative of light transmitted by the optical device 202₂. In other words, the same signal can be used to determine different parameters, informative of different optical devices of the examination tool 102.

In some examples, it is possible to use two consecutive detectors (such as detectors 230 and 240). The first detector measures a first signal which can be used to determine first parameters informative of a first optical device, and the second detector measures a second signal which can be used to determine second parameters informative of a second optical device.

Note that in some examples, it is possible to use a signal measured by a detector detecting light transmitted by a given optical device to be calibrated, before it reaches the next optical device of the examination tool 102. Assume, for example, that it is desired to calibrate the optical device 202₁. The signal measured by the detector 210 can be used to determine one or more measured values for one or more given parameters characterizing light transmitted by the at least one given optical device 202₁. In this example, detector 210 measures light transmitted by the optical device 202₁ before it reaches the next optical device 202₂, and the parameters informative of the optical device 202₁ are determined using the signal measured by the detector 210. This is however not limitative. In some examples, it is possible to command an optical element to deviate the optical path of light transmitted by the optical device so as to transmit along a different optical path comprising the detector. For example, it is possible to command the optical element 209 to deviate from the optical path of light transmitted by the optical device 202₁ so as to transmit along a second optical path comprising the at least one imaging sensor 210.

The one or more parameters which are measured to characterize light transmitted by the given optical device to be calibrated, can be informative of the quality of light transmitted by the given optical device.

The one or more parameters, which are derived from the signal measured by the detector collecting light transmitted by the given optical device, can include e.g., at least one of (note that this list is not limitative): symmetry of the signal, width of the signal, average value of the signal (corresponding to the average grey level intensity), dimensions of one or more lobes of the signal, flatness of the signal (which can be measured using the peak-to-peak difference of the signal), maximal value of the signal, minimal value of the signal, etc. Note that these parameters can be measured along one direction (e.g., X or Y direction) and/or along two directions (X and Y directions).

As mentioned above, the values for the given parameters characterizing light transmitted by the given optical device to be calibrated can be obtained for different values of the position or of the orientation of the given moveable element.

As described hereinafter, the position and/or the orientation of the given moveable element can be modified based on an input of an operator (who provides an input to the examination tool 102, using an interface of the examination tool 102), and/or based on a command generated by at least one processing circuitry (such as the processing circuitry 150) and transmitted to the examination tool 102. A modification in the values of the position and/or of the orientation of the given moveable element generally impacts the measured values of the given parameters.

In some examples, operation 300 can include obtaining the values for the one or more given parameters for few different positions of the given moveable element (e.g., 15 different positions or orientations—this value is not limitative). In other words, for a first position or orientation of the given moveable element of a given optical device, a first set of values is obtained for the parameters characterizing light transmitted by the given optical device; for a second position or orientation of the given moveable element of the given optical device, a second set of values is obtained for the parameters characterizing light transmitted by the given optical device. This can be repeated for a plurality of N different positions and/or orientation of the given moveable element of each given optical device to be calibrated.

The method of FIG. 3A further includes obtaining (operation 310) one or more required values for the one or more given parameters.

The required values correspond to a state of the given optical device for which it is in a calibrated state. For example, assume that a given parameter corresponds to the average grey level intensity of the signal detected by the detector. The required values can correspond to an interval (including a minimal value and a maximal value) in which the average grey level intensity has to be confined in an optimal or calibrated state of the given optical device. In some examples, the required value of a given parameter corresponds to a single required value (and not to a range of required values).

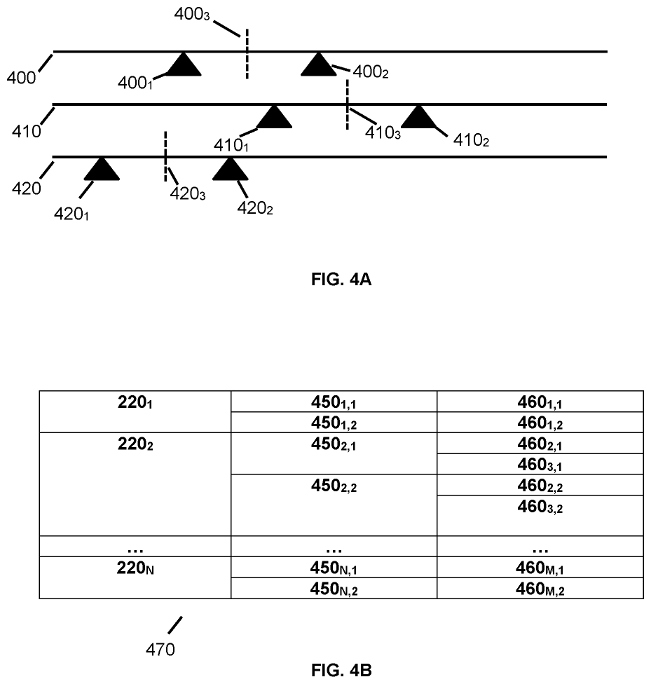

FIG. 4A illustrates, in a graphical manner, the required values for three different parameters 400, 410, and 420. The required values for the first parameter 400 correspond to the interval between the first value 400₁ and the second value 400₂. The required values for the second parameter 410 correspond to the interval between the first value 410₁ and the second value 410₂. The required values for the third parameter 420 correspond to the interval between the first value 420₁ and the second value 420₂.

Note that the required values can be provided by the manufacturer of the examination tool 102, and/or by a user of the examination tool 102, or can correspond to predefined values obtained using simulation and/or experimental data.

The method of FIG. 3A further includes using (operation 320) the data set and the one or more required values to determine data informative of at least one of a calibrated position or a calibrated orientation of the given moveable element enabling the one or more parameters characterizing light transmitted by the given optical device to have values matching the one or more required values according to a matching criterion. In some examples, the data informative of a calibrated position or a calibrated orientation of the given moveable element can be expressed as number of counts of a motor (or of another actuator) controlling the given moveable element.

The matching criterion can define to which extent the values of the given parameters (measured after the calibration process) should match the required values. In some examples, it can be required that the values of the given parameters are strictly within the interval defined by the required values. In some examples, the matching criterion is met when a cost function (or loss function), informative of a difference between the values of the parameters and the required values, has reached a minimal value (below a threshold). In some examples, it can be required to determine a calibrated position or a calibrated orientation of a given moveable element of a given optical device enabling the value of each given parameter (informative of the given optical device) to be close to the center (see e.g., 400₃, 410₃ and 420₃ in FIG. 4A) of the interval defined by the required values. In some examples, it can be required that the value of each given parameter does not exceed the maximal value (of the interval defined by the required values for this given parameter) by a certain amount, or are not below the minimal value of the interval by a certain amount. In some examples, it can be required that the value of each given parameter is not too close to the edges of the required interval of this given parameter. This is however not limitative.

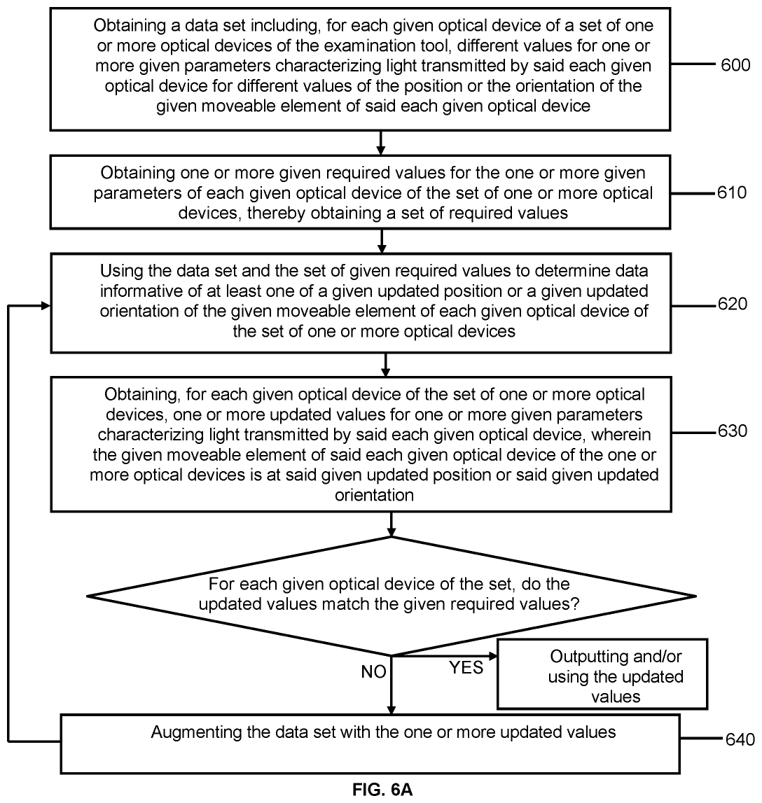

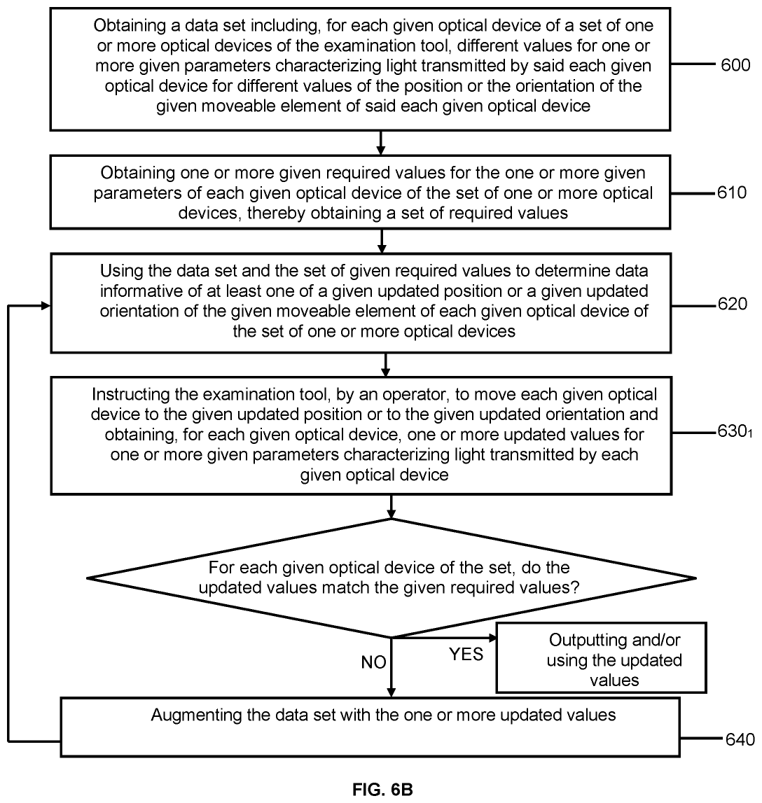

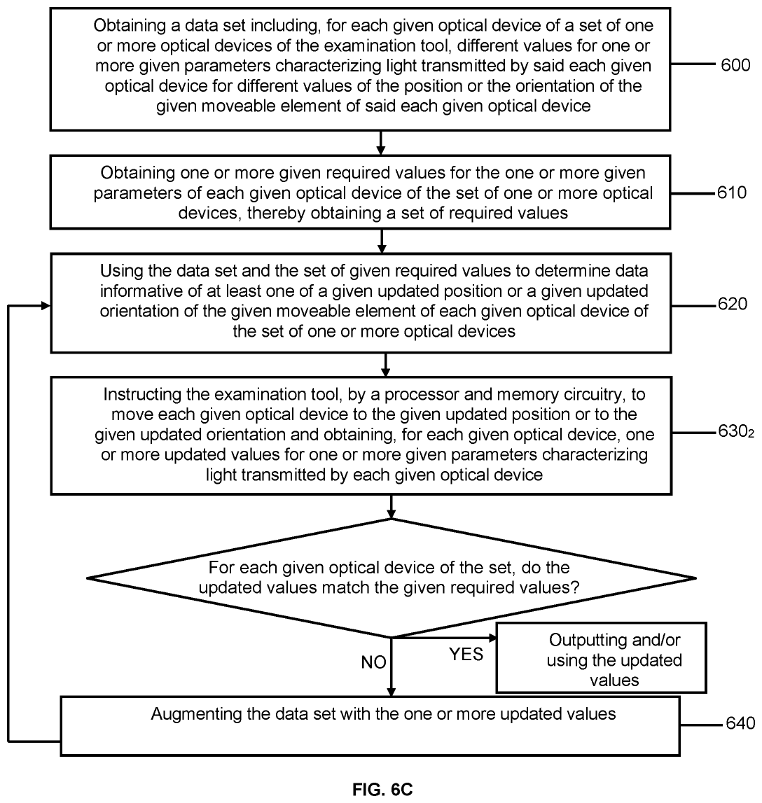

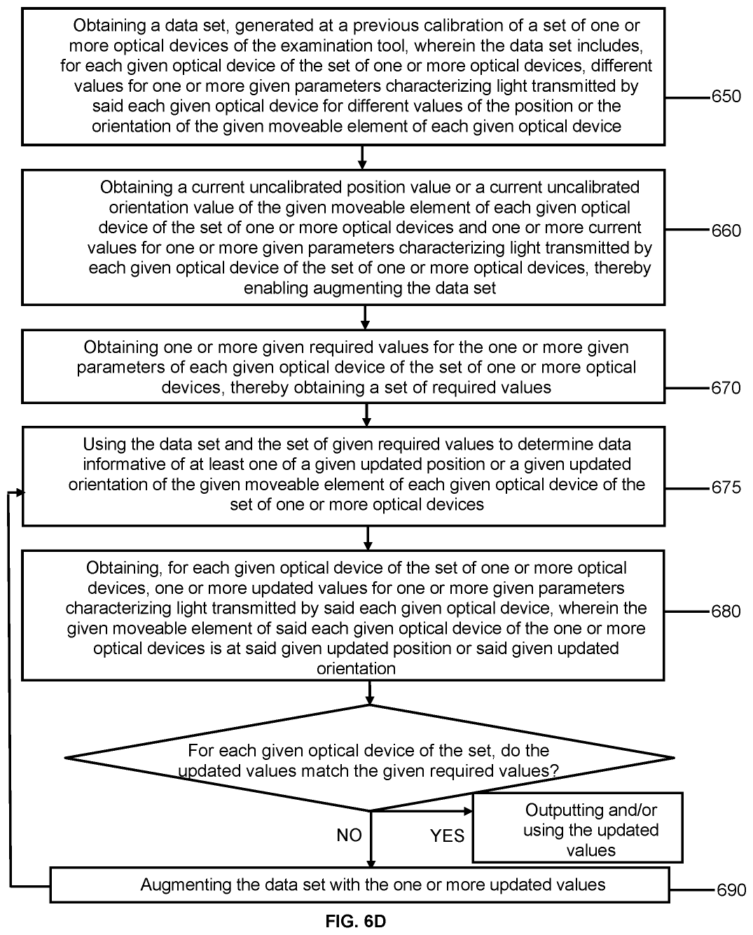

Operation 320 can include using feeding the data set (obtained at operation 300) and the one or more required values (operation at operation 310) to an optimization algorithm (such as optimization algorithm 105) to determine data informative of at least one of a calibrated position or a calibrated orientation of the given moveable element. The optimization algorithm attempts to determine which calibrated position or orientation enables obtained values for the given parameters which comply with the requires values. In some examples, determination of the calibrated position or orientation by the optimization algorithm can be performed using an iterative method. This will be described further in detail hereinafter (see e.g., FIGS. 6A to 6D).

According to some examples, the optimization algorithm 105 does not need to be trained in order to be used to determine the data informative of at least one of a calibrated position or a calibrated orientation of the given moveable element. For example, as mentioned above, a Bayesian optimizer can be used to determine the data informative of at least one of a calibrated position or a calibrated orientation of the given moveable element. This reduces the time required to calibrate the examination tool. The Bayesian optimizer can be fed with the data set (obtained at operation 300) and the one or more required values (operation at operation 310) to determine data informative of at least one of a calibrated position or a calibrated orientation of the given moveable element. Usage of a Bayesian optimizer for determining the calibrated position(s) and/or orientation(s) enables finding a solution with a minimal size of the data set, and without requiring prior training.

The method of FIG. 3A enables determining which position or orientation the given moveable element should reach in order to calibrate the given optical device.

Once the calibrated position or orientation of the given moveable element has been determined, it is possible to control the given moveable element so as to make it reach this calibrated position or orientation. In some examples, a human operator can use an interface of the examination tool 102 in order to instruct the given moveable element to reach the calibrated position or the calibrated orientation. In other examples, the processing circuitry 150 can generate a command and transmit the command to the examination tool 102 using the interface 104. The command triggers the examination tool 102 to automatically modify the current position or the current orientation of the given moveable element, in order to reach the calibration position or the calibrated orientation.

Note that the method of FIG. 3A can be used to calibrate a set of a plurality of given optical devices of the examination tool 102, each associated with a respective given moveable element. This is illustrated in FIG. 3B.

Assume that at least one of a position or an orientation of a respective given moveable element of each given optical device of a set of optical devices has to be calibrated. Assume, for example, that the set of optical devices, for which a calibration is required, correspond to the optical devices 202ᵢ to 202j, with i different from j, 1≤i≤N and 1≤j≤N.

The method of FIG. 3B includes obtaining (operation 300₁), for each given optical device of the set of optical devices, given values for one or more given parameters, characterizing light transmitted by the given optical device for different values of the position or of the orientation of the given moveable element of the given optical device. As a consequence, a data set informative of the set of optical devices is obtained.

A non-limitative example of a data set 470 is depicted in FIG. 4B. The data set 470 stores values for the position/orientation of the moveable element of each given optical device to be calibrated, and values 460 for the parameters characterizing light transmitted by the optical devices to be calibrated. In the data set 470 of FIG. 4B:
the position/orientation 450_{1,1} of the moveable element of the optical device 220₁ is associated with a value 460_{1,1} of the parameter characterizing light transmitted by the optical device 220₁;
the position/orientation 450_{1,2} of the moveable element of the optical device 220₁ is associated with a value 460_{1,2} of the parameter characterizing light transmitted by the optical device 220₁;
the position/orientation 450_{2,1} of the moveable element of the optical device 220₂ is associated with a first value 460_{2,1} of a first parameter characterizing light transmitted by the optical device 220₂ and with a second value 460_{3,1} of a second parameter characterizing light transmitted by the optical device 220₂;
the position/orientation 450_{2,2} of the moveable element of the optical device 220₂ is associated with a first value 460_{2,2} of a first parameter characterizing light transmitted by the optical device 220₂ and with a second value 460_{3,2} of a second parameter characterizing light transmitted by the optical device 220₂;
the position/orientation 450_{N,1} of the moveable element of the optical device 220_{N} is associated with a value 460_{M,1} of the parameter characterizing light transmitted by the optical device 220_{N};
the position/orientation 450_{N,2} of the moveable element of the optical device 220_{N} is associated with a value 460_{M,2} of the parameter characterizing light transmitted by the optical device 220_{N}.

As mentioned above, in order to characterize light transmitted by a given optical device, it is possible to use a detector located, on the optical path, immediately after the given optical device (which detects light before it reaches the next optical device), or a detector located after several optical devices on the optical path (which detects light transmitted by the given optical device after it has gone through the optical devices of the examination tool 102 which are next in line).

In some examples, assume that a signal is measured by a given detector (such as detector 230). It is possible to determine, based on the signal, values for a first set of one or more parameters characterizing light transmitted by a first optical device, and values for a second set of one or more parameters characterizing light transmitted by a second optical device.

In some examples, assume that the examination tool 102 includes two detectors (a first detector and a second detector), located one after the other along the optical path. The signal measured by the first detector can be used to determine values for a first set of one or more parameters characterizing light transmitted by a first optical device, and the signal measured by the second detector can be used to determine values for a second set of one or more parameters characterizing light transmitted by a second optical device.

In some examples, one or more of the given parameters used for characterizing light transmitted by a first given optical device (of the optical devices 202ᵢ to 202ⱼ) can be different from one or more of the given parameters used for characterizing light transmitted by a second given optical device (of the optical devices 202ᵢ to 202ⱼ). This is however not limitative.

The method of FIG. 3B further includes obtaining (operation 310₁) one or more given required values for the one or more given parameters of each given optical device of the set of optical devices. This enables obtaining a set of required values. As mentioned above, the parameters can differ between the different optical devices. In addition, in some examples, it can occur that, for a given parameter, the required values differ from a given optical device to another. This is not limitative.

The method of FIG. 3B further includes using (operation 320₁) the data set and the set of required values to determine data informative of at least one of a calibrated position or a calibrated orientation of the given moveable element of each given optical device of the set of optical devices, enabling the one or more given parameters, characterizing light transmitted by each given optical device of the set of optical devices, to have values matching the one or more given required values according to a matching criterion. In other words, for each given optical device of the set of optical devices, a calibrated position or orientation is determined.

According to some examples, operation 320₁ includes determining, simultaneously, data informative of at least one of a calibrated position or a calibrated orientation of moveable elements of the entire set of optical devices, enabling the one or more given parameters characterizing light transmitted by each given optical device of the set of optical devices to have values matching the one or more given required values according to a matching criterion. This reduces the time required to calibrate the examination tool 102. In particular, in some examples, operation 320₁ can include feeding the data set (obtained at operation 300₁) and the set of required values (operation at operation 310₁) to an optimization algorithm (such as optimization algorithm 105) to determine, simultaneously, data informative of at least one of a calibrated position or a calibrated orientation of the given moveable element of each given optical device of the set of optical devices.

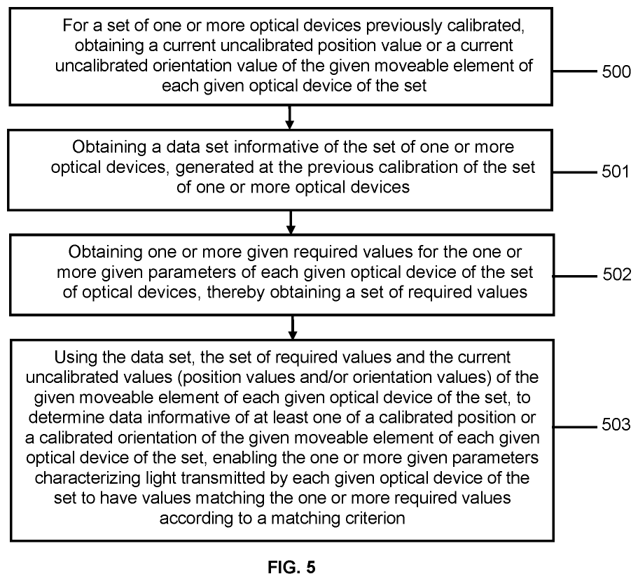

Attention is now drawn to FIG. 5.

Assume that a set of one or more optical devices of the examination tool 102 has already been calibrated. Assume that, after a period of time, it is intended to calibrate, once again, one or more optical devices of this set. In some examples, the examination tool 102 did not encounter significant hardware modification during this period of time. It is therefore possible to use the data set informative of the set of one or more optical devices, obtained during previous calibration(s) (see e.g., operations 300 and 300₁). Indeed, since no significant hardware modification of the examination tool 102 has been performed, it can be expected that this data set still correctly reflects operation of the examination tool 102.

The method of FIG. 5 includes obtaining (operation 500) a current uncalibrated position value or a current uncalibrated orientation value of the given moveable element of each given optical device of the set of one or more optical devices.

The method of FIG. 5 further includes obtaining (operation 501) the data set informative of the set of one or more optical devices, generated during previous calibration(s) of the set of one or more optical devices (see e.g., operations 300 and 300₁).

The method of FIG. 5 further includes obtaining (operation 502) one or more given required values for the one or more given parameters of each given optical device of the set of optical devices. Note that the given required values can be the same as the one used during previous calibration(s), or can be different values. This enables obtaining a set of required values. As mentioned above, the parameters can differ between the different optical devices. In addition, in some examples, it can occur that for a given parameter, the required values differ from one given optical device to another. This is not limitative.

The method of FIG. 5 further includes using (operation 503) the data set, the set of required values, and the current uncalibrated values (position values and/or orientation values) of the given moveable element of each given optical device of the set, to determine data informative of at least one of a calibrated position or a calibrated orientation of the given moveable element of each given optical device of the set, enabling the one or more parameters characterizing light transmitted by each given optical device of the set to have values matching the one or more given required values according to a matching criterion.

Operation 502 can include feeding the data set (obtained at operation 501), the set of required values (operation at operation 502) and the current uncalibrated values (position values and/or orientation values) of the given moveable element of each given optical device of the set, to an optimization algorithm (such as optimization algorithm 105) to determine data informative of at least one of a calibrated position or a calibrated orientation of the given moveable element of each given optical device of the set. The optimization algorithm attempts to determine which calibrated position or orientation enables obtaining values for the given parameters which comply with the given required values. In some examples, determination of the calibrated position or orientation by the optimization algorithm can be performed using an iterative method. This will be described in further detail hereinafter.

Attention is now drawn to FIG. 6A, which describes determination of the calibrated position and/or orientation of one or more moveable elements, based on an iterative process.

The method of FIG. 6A includes obtaining (operation 600) a data set, including, for each given optical device of a set of one or more optical devices of the examination tool 102, different values for one or more given parameters characterizing light transmitted by each given optical device for different values of the position or the orientation of the given moveable element of each given optical device.

In some examples, operation 600 can be performed using an operator. The operator can enter, using an interface of the examination tool 102, different values for the position and/or orientation of the given moveable element of each given optical device of the set. The corresponding values of the given parameters can be computed by a processor and memory circuitry based on the signal(s) measured by one or more detector(s) of the examination tool 102, as explained with reference to operation 300 and 300₁.

In some examples, operation 600 can be performed using a processor and memory circuitry (such as the processing circuitry 150). For each given moveable element, a set of different positions and/or different orientations can be generated. This set of different positions and/or different orientations can be generated using techniques such as design of experiments, or other methods enabling generation of data (e.g., methods enabling generation of random data). This is however not limitative. The processing circuitry 150 can send a command to the examination tool 102 to move each moveable element according to the different positions and/or orientations of the set. The processing circuitry 150 then obtains the corresponding values for the given parameters, for each position and/or orientation of the set.

The method of FIG. 6A further includes (operation 610) obtaining one or more given required values for the one or more given parameters of each given optical device of the set of optical devices, thereby obtaining a set of required values. As mentioned above, the one or more given required values can correspond to a range of values for each given parameter.

The method of FIG. 6A further includes (operation 620) using the data set and the set of given required values to determine data informative of at least one of a given updated position or a given updated orientation of the given moveable element of each given optical device of the set of one or more optical devices.

In particular, operation 620 can include feeding the data set and the set of given required values to an optimization algorithm, which attempts to determine a given updated position or a given updated orientation of the given moveable element of each given optical device which enables the given parameters to approximate, to the greatest extent possible, the given required values. The optimization algorithm can attempt to minimize a loss function (also called a cost function), which is informative of the difference between the given parameters and the given required values. In some examples, the optimization algorithm can include a Bayesian optimizer. The Bayesian optimizer can attempt to build a model (such as a Gaussian model) which fits the relationship between the parameters of the data set and the corresponding values of the position/orientation of the moveable elements and use this model to determine updated values of the position/orientation to minimize the cost function.

In some examples, operation 620 includes using a cost function which is convex. This can be performed by squaring the difference between the values of the parameters (to be determined by the optimization algorithm), and the required values for the parameters.

In some examples, the cost function can be built to attempt to force each parameter to be equal to (or close to) the center of the interval of the required values.

The method of FIG. 6A further includes (operation 630) obtaining, for each given optical device of the set of one or more optical devices, one or more updated values for one or more given parameters characterizing light transmitted by each given optical device, wherein the given moveable element of each given optical device of the one or more optical devices is at the given updated position or said given updated orientation. Operation 630 enables obtaining a set of one or more updated values for the parameters characterizing light transmitted by set of one or more optical devices.

Note that operation 630 can be performed either using a human operator, or automatically.

FIG. 6B illustrates the method of FIG. 6A in which a human operator is involved. As visible in FIG. 6B, operation 630₁ includes instructing the examination tool 102, by an operator, to move each given optical device of the set of one or more given optical devices to the given updated position or to the given updated orientation. The operator can use an interface of the examination 102 to enter the updated position or updated orientation for the given moveable element of each given optical device of the set of one or more given optical devices. Once the given moveable element of each given optical device of the set of one or more given optical devices has reached its updated position or updated orientation, the operator can read the updated values of the given parameters on a display of the examination tool 102 (or of another system coupled to the examination tool 102) and provide them to the PMC 150 which performs the method of FIG. 6B.

FIG. 6C illustrates the method of FIG. 6A in which operation 630 is performed automatically. As visible in FIG. 6C, operation 6302 includes transmitting a command generated by the processing circuitry 150 to the examination tool 102, to move each given optical device to the given updated position or to the given updated orientation. Once the given moveable element of each given optical device of the set of one or more given optical devices has reached its updated position or updated orientation, the processing circuitry 150 can obtain, from the examination tool 102, the updated values of the given parameters, and provide them to the processing circuitry 150 which performs the method of FIG. 6C.

If the set of one or more updated values matches the one or more required values according to a matching criterion, the method can stop. Indeed, this indicates that the set of one or more optical devices is calibrated. In some examples, the method can include outputting at least one of calibrated position of each optical device of the set of one or more optical devices, calibrated orientation of each optical device of the set of one or more optical devices, updated values of the one or more given parameters of the set of one or more optical devices, etc.

If the set of one or more updated values does not match the one or more required values according to the matching criterion, this indicates that one or more additional iterations of the method of FIG. 6A are required to determine the calibrated position and/or orientation of the set of one or more optical devices. In this case, the method of FIG. 6A can further include augmenting (operation 640) the data set with the set of one or more updated values. In other words, an updated data set is obtained, which includes the data set previously obtained at operation 600, and the set of one or more updated values obtained at operation 630 (that is to say the one or more updated values and the corresponding values of the position or orientation).

At least some of the operations of the method of FIG. 6A can be repeated. In particular, operations 620 to 640 can be repeated, until a stopping criterion is met.

In some examples, operations 620 to 640 can be repeated, until the one or more given parameters characterizing light transmitted by each given optical device of the set of one or more optical devices have values matching the one or more given required values according to the matching criterion. In some examples, the matching criterion is met when the loss function (cost function) has a value below a threshold. In some examples, the matching criterion is met when the loss function (cost function) has a value below a threshold for a certain number of iterations of the method (this indicates that the solution is stable).

As can be understood from the methods of FIGS. 6A to 6C, these methods enable determining, in an iterative manner, the calibrated position/orientation of the moveable element of each optical device of the examination tool 102. In particular, the method starts with a limited data set of values, including, for different positions or orientations the moveable element of each optical device, corresponding values of the parameter(s) characterizing light transmitted by each optical device. Each time the optimization algorithm proposes updated value(s) for the position/orientation of the moveable element of each optical device, the corresponding values of the parameters are stored in order to augment the original limited data set. The method can be repeated until the calibration position/orientation of each optical device is obtained.

As can be understood from the methods of FIGS. 6A to 6C, no prior training of the optimization algorithm is required. It provides, at each iteration, its estimate of the best solution for the position and/or orientation of the moveable element(s), and the data set is enriched at the next iteration with measured values of the parameter(s) characterizing light transmitted by each optical device at the position and/or orientation of the moveable element(s) determined at one or more previous iteration(s). The system learns while it predicts and does not need prior training.

As can be understood from the methods of FIGS. 6A to 6C, these methods enable determining, simultaneously, the calibrated position/orientation of a plurality of optical devices of the examination tool 102.

At least some (or all) of the operations described with reference to one of the methods of FIGS. 6A to 6C can be repeated from time to time, in order to recalibrate the examination tool 102. Following a calibration of the examination tool 102 using one of the methods of FIGS. 6A to 6C, an augmented data set, informative of the optical devices, has been obtained. This augmented data set includes, for various positions and/or orientations of the given moveable element of each given optical device, corresponding values for parameters characterizing light transmitted by the given optical device.

In some examples, the examination tool 102 does encounter hardware modification during this period of time. Therefore, it can be expected that the data set obtained at a previous calibration does not accurately reflect the actual behavior of the examination tool 102. In this case, in order to recalibrate the examination tool 102, one of the methods of FIGS. 6A to 6C can be repeated (with a new data set).

In some examples, the examination tool 102 does not encounter significant hardware modification during this period of time. In this case, in order to recalibrate the examination tool 102, it is possible to perform the operations depicted in FIG. 6D.

The method of FIG. 6D includes obtaining (operation 650) a data set, generated at a previous calibration of a set of one or more optical devices of the examination tool 102. This data set can correspond to the augmented data set obtained at the end of the calibration performed using one of the methods described with reference to FIGS. 6A to 6C. This data set includes, for each given optical device of the set of one or more optical devices, different values for one or more given parameters characterizing light transmitted by each given optical device, for different values of the position or the orientation of the given moveable element of each given optical device.

The method of FIG. 6D further includes obtaining (operation 660) a current uncalibrated position value or a current uncalibrated orientation value of the given moveable element of each given optical device of the set of one or more optical devices, and one or more current values for one or more given parameters characterizing light transmitted by each given optical device of the set of one or more optical devices. As mentioned above, the current position or orientation of each given moveable element can be either provided by an operator interacting with a display of the examination tool 102, or can be obtained by the processing circuitry 150 interacting with the examination tool 102. This enables augmenting the original data set (obtained from previous calibration(s)), with the current values of the parameters of each optical device for the current values of the position or orientation of the moveable element of each optical device.

The method of FIG. 6D further includes obtaining (operation 670) one or more given required values for the one or more given parameters of each given optical device of the set of one or more optical devices, thereby obtaining a set of required values. Note that this set of required values can be the same as the set used in previous calibration(s), or can be different.

The method of FIG. 6D further includes using (operation 675) the data set and the set of given required values to determine data informative of at least one of a given updated position or a given updated orientation of the given moveable element of each given optical device of the set of one or more optical devices.

In particular, operation 675 can include feeding the data set and the set of given required values to an optimization algorithm, which attempts to determine a given updated position or a given updated orientation of the given moveable element of each given optical device which enables the given parameters to approximate, to the greatest extent possible, the given required values. Operation 675 is similar to operation 620, and is not described again.

The method of FIG. 6D further includes obtaining (operation 680), for each given optical device of the set of one or more optical devices, one or more updated values for one or more given parameters characterizing light transmitted by said each given optical device, wherein the given moveable element of said each given optical device of the one or more optical devices is at said given updated position or said given updated orientation. Operation 680 is similar to operation 630, and is therefore not described again.

If the set of one or more updated values matches the one or more required values according to a matching criterion, the method can stop. Indeed, this indicates that the set of one or more optical devices is calibrated. In some examples, the method can include outputting at least one of calibrated position of each optical device of the set of one or more optical devices, calibrated orientation of each optical device of the set of one or more optical devices, updated values of the one or more given parameters of the set of one or more optical devices, etc.

If the set of one or more updated values does not match the one or more required values according to the matching criterion, this indicates that one or more iterations of the method of FIG. 6D are required to determine the calibrated position and/or orientation of the set of one or more optical devices. In this case, the method of FIG. 6D can further include augmenting (operation 690) the data set with the set of one or more updated values. In other words, an updated data set is obtained, which includes the data set previously obtained at operation 660, and the set of one or more updated values obtained at operation 680. In particular, operations 675 to 690 can be repeated, until a stopping criterion is met (see above examples of stopping criterion). This enables recalibrating the set of one or more optical devices.

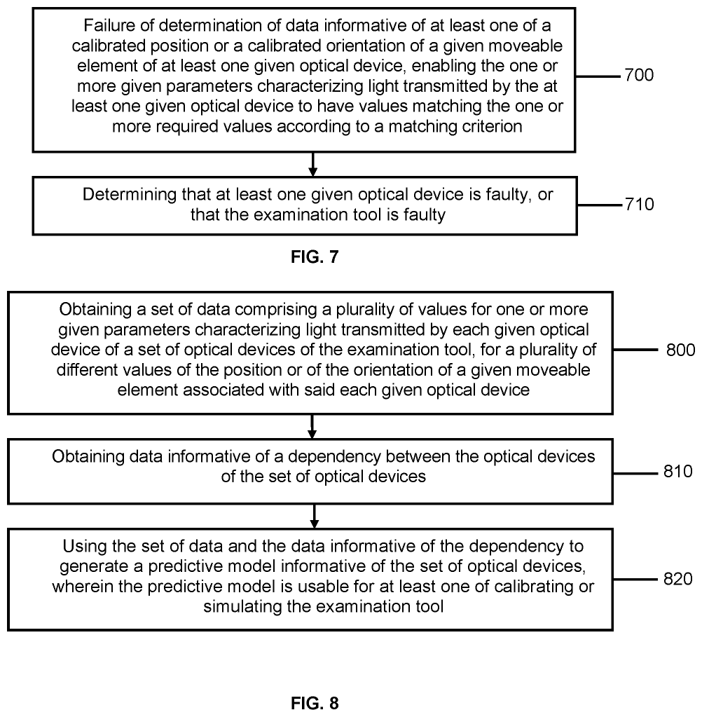

Attention is now drawn to FIG. 7.

Assume that the various methods described above failed to identify (see operation 700), for a given optical device, a calibrated position or a calibrated orientation of the given moveable element of the given optical device, enabling the one or more given parameters characterizing light transmitted by the given optical device to have values matching the one or more required values according to a matching criterion.

In response to this failure, the method can include determining (operation 710) that the given optical device is faulty, or that the examination tool 102 is faulty. Indeed, if no calibrated position or orientation can be determined, this indicates that there is a failure in the given optical device itself and/or in the examination tool 102 itself. This can be output to a user. In some examples, an alert can be raised.

In some examples, the method of FIG. 7 can rely on the usage of an optimization algorithm (such as a Bayesian optimizer) associated with a cost function which is convex, which “guarantees” that a calibrated position and/or orientation should be found. If a calibrated position and/or orientation cannot be found, this indicates that the this indicates that there is a failure in the given optical device itself and/or in the examination tool 102 itself.

Attention is now drawn to FIG. 8.

The method of FIG. 8 includes obtaining (operation 800) a set of data comprising a plurality of values for one or more given parameters characterizing light transmitted by each given optical device of one or more optical devices of the examination tool 102, for a plurality of different values of the position or of the orientation of a given moveable element associated with each given optical device.

For example, for the given optical device 202₁, the position or orientation of the given moveable element associated with the given optical device 202₁ is modified according to different values: for each given value of the position (or of the orientation), corresponding values for one or more given parameters characterizing light transmitted by the given optical device 202₁ at this given position or orientation are obtained.

The same method can be applied to one or more other optical devices (see 202₂ to 202_{N}) of the examination tool 102.

The set of data obtained at operation 800 can be informative of a single optical device of the examination tool 102, or of a plurality of optical devices of the examination tool 102.

In some examples, the set of data can be obtained as a product of at least one of the methods of FIG. 6A, FIG. 6B, FIG. 6C or FIG. 6D. Indeed, in these methods, an iterative process is performed, in which the position or orientation of one or more given moveable element(s) is/are modified until the calibrated position or calibrated orientation is reached. At each iteration, the corresponding values of the parameters are determined (see operations 630, 630₁ and 680). This set of data can be stored and used as part of the set of data obtained in the method of FIG. 8.

In some examples, the set of data can be obtained using an operator. The operator can enter, using an interface of the examination tool 102, different values for the position or orientation of the given moveable element of each given optical device. The corresponding values of the parameters characterizing light transmitted by each given optical device can be computed by a processor and memory circuitry based on the signal(s) measured by one or more detector(s) of the examination tool 102.

In some examples, the processing circuitry 150 sends a command to the examination tool 102 to move each moveable element according to different positions and/or orientations. The processing circuitry 150 then obtains the corresponding values for the given parameters, for each different position and/or orientation of each moveable element.

The method of FIG. 8 further includes obtaining (operation 810) data informative of a dependency between the optical devices of the set of optical devices. This data can indicate the order according to which the optical devices are arranged along the optical path of the examination tool 102. For example, this data can indicate that the optical device 202₁ is located before the optical device 202₂, which is located before the optical device 2023, etc. The data can indicate the connections between the inputs and outputs of the different optical devices of the set. In some examples, the data can be stored as a graph, in which each connection connects the output of a given optical device 202; to the input of the next optical device 202ᵢ₊₁. This is however not limitative. This dependency is useful to build a more accurate predictive model. Indeed, the position or orientation of a given optical device 202; does not impact the light transmitted by an optical device 202ⱼ(with j<i) located upstream on the optical path 201 of the examination tool 102, and this can be taken into account to generate the predictive model.

The method of FIG. 8 further includes using (operation 820) the set of data and the data informative of the dependency to generate a predictive model informative of the set of optical devices.

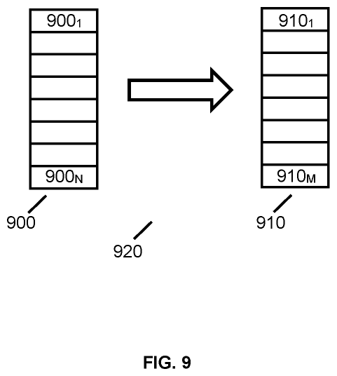

A non-limitative example of the predictive model 920 is depicted in FIG. 9. The predictive model links the position or orientation of the different moveable elements of the set of optical devices to the parameters characterizing light transmitted by the set of optical devices. The predictive model can predict the impact of a modification of a position or orientation (900₁ to 900_{N}) of the moveable element of each optical device (202₁ to 202_{N}) on the various parameters (910₁ to 910_{M}) characterizing light transmitted by the optical devices. In some examples, it can store, for each optical device, a list of weights, wherein each weight of the list is informative of the impact of the position or orientation of the moveable element of the optical device on one (or more) of the parameters characterizing light transmitted by the optical devices.

In some examples, the predictive model can be built using structural equation modelling. Python libraries (such as semopy) can be used to build the predictive model. This is however not limitative.

In some examples, the predictive model can be represented as a graph with connections between the different optical devices. Each connection is associated with a weight. For example, assume that a connection links a first optical device to a second optical device: the weight indicates the impact of a modification of the position or orientation of the moveable element of the first optical device on the given parameters characterizing light transmitted by the second optical device.

In some examples, the predictive model can be used to estimate, for a given value of the position or of the orientation of a first given moveable element of a first given optical device of the set of optical devices, one or more predicted values for one or more given parameters characterizing light transmitted by the first given optical device, and/or or by one or more second given optical device(s) different from the first given optical device.

In some examples, a user interface can be displayed to an operator. The user interface enables the operator to simulate a modification of the position or of the orientation of a moveable element of a given optical device, and displays the predicted impact on the parameters of the given optical device (and/or the predicted impact on the parameters of other optical devices of the examination tool 102), based on the predictive model.

The predictive model generated by the method of FIG. 8 can be used for various purposes. In some examples, the predictive model is usable for simulating the examination tool 102. For example, an operator can use the predictive model to predict the impact of the modification of a position/orientation of each moveable element on the various parameters characterizing light transmitted by the various optical devices.

In some examples, it is intended to train an operator to learn how to manually calibrate the examination tool 102 (note that the various methods described above enable automatically calibrating the examination tool 102). Instead of training the operator on the actual examination tool 102 (which would prevent the examination tool 102 from being used for examination purposes), the operator can be trained on a simulated examination tool 102, which uses the predictive model to simulate the examination tool 102.

In some examples, the predictive model can be used for calibration purposes. Assume that it is desired to calibrate a set of one or more optical devices, wherein each given optical device of the set is associated with a given moveable element with a certain position or certain orientation. At this certain position or orientation, one or more current values of one or more given parameters characterizing light transmitted by each given optical device can be obtained. An optimization algorithm can be fed with the predictive model, the current position/orientation of the moveable element of each given optical device to be calibrated and the current values of the parameters of each given optical device to be calibrated. Examples of an optimization algorithm that can be used include e.g., Bayesian optimizer. The optimization algorithm determines, using the predictive model, the calibrated position or orientation, enabling the one or more given parameters characterizing light transmitted by the moveable element of each given optical device to match required values according to a matching criterion.

It is to be understood that the invention is not limited in its application to the details set forth in the description contained herein or illustrated in the drawings.

In the detailed description, numerous specific details are set forth in order to provide a thorough understanding of the disclosure. However, it will be understood by those skilled in the art that the presently disclosed subject matter may be practiced without these specific details. In other instances, well-known methods, procedures, components, and circuits have not been described in detail so as not to obscure the presently disclosed subject matter.

Unless specifically stated otherwise, it is appreciated that throughout the specification discussions utilizing terms such as “obtaining”, “using”, “determining”, “generating”, “transmitting”, “estimating”, “feeding”, “communicating”, or the like, refer to the action(s) and/or process(es) of a computer that manipulate and/or transform data into other data, said data represented as physical, such as electronic, quantities and/or said data representing the physical objects.

The terms “computer” or “computer-based system” should be expansively construed to include any kind of hardware-based electronic device with a data processing circuitry (e.g., digital signal processor (DSP), a GPU, a TPU, a field programmable gate array (FPGA), an application specific integrated circuit (ASIC), microcontroller, microprocessor etc.), including, by way of non-limiting example, the computer-based system 103 of FIG. 1 and respective parts thereof disclosed in the present application. The data processing circuitry (designated also as processing circuitry) can comprise, for example, one or more processors operatively connected to computer memory, loaded with executable instructions for executing operations, as further described below. The data processing circuitry encompasses a single processor or multiple processors, which may be located in the same geographical zone, or may, at least partially, be located in different zones, and may be able to communicate together. The one or more processors can represent one or more general-purpose processing devices such as a microprocessor, a central processing unit, or the like. More particularly, a given processor may be one of: a complex instruction set computing (CISC) microprocessor, a reduced instruction set computing (RISC) microprocessor, a very long instruction word (VLIW) microprocessor, a processor implementing other instruction sets, or a processor implementing a combination of instruction sets. The one or more processors may also be one or more special-purpose processing devices such as an application specific integrated circuit (ASIC), a field programmable gate array (FPGA), a digital signal processor (DSP), a network processor, or the like. The one or more processors are configured to execute instructions for performing the operations and steps discussed herein.

The memories referred to herein can comprise one or more of the following: internal memory, such as, e.g., processor registers and cache, etc., main memory such as, e.g., read-only memory (ROM), flash memory, dynamic random access memory (DRAM) such as synchronous DRAM (SDRAM) or Rambus DRAM (RDRAM), etc.

The terms “non-transitory memory” and “non-transitory storage medium” used herein should be expansively construed to cover any volatile or non-volatile computer memory suitable to the presently disclosed subject matter. The terms should be taken to include a single medium or multiple media (e.g., a centralized or distributed database, and/or associated caches and servers) that store the one or more sets of instructions. The terms shall also be taken to include any medium that is capable of storing or encoding a set of instructions for execution by the computer and that cause the computer to perform any one or more of the methodologies of the present disclosure. The terms shall accordingly be taken to include, but not be limited to, a read only memory (“ROM”), random access memory (“RAM”), magnetic disk storage media, optical storage media, flash memory devices, etc.

It is to be noted that while the present disclosure refers to the processing circuitry 150 being configured to perform various functionalities and/or operations, the functionalities/operations can be performed by the one or more processors in processing circuitry 150 in various ways. By way of example, the operations described hereinafter can be performed by a specific processor, or by a combination of processors. The operations described above can thus be performed by respective processors (or processor combinations) in the processing circuitry 150, while, optionally, at least some of these operations may be performed by the same processor. The present disclosure should not be limited to be construed as one single processor always performing all the operations.

The term “specimen” used in this specification in this masks, and other structures, combinations and/or parts thereof used for manufacturing semiconductor integrated circuits, magnetic heads, flat panel displays, and other semiconductor-fabricated articles.

The term “examination” used in this specification should be expansively construed to cover any kind of metrology-related operations, as well as operations related to detection and/or classification of defects in a specimen during its fabrication. Examination is provided by using non-destructive examination tools during or after manufacture of the specimen to be examined. By way of non-limiting example, the examination process can include runtime scanning (in a single or in multiple scans), sampling, reviewing, measuring, classifying and/or other operations provided with regard to the specimen or parts thereof, using the same or different inspection tools. Likewise, examination can be provided prior to manufacture of the specimen to be examined, and can include, for example, generating an examination recipe(s) and/or other setup operations. It is noted that, unless specifically stated otherwise, the term “examination”, or its derivatives used in this specification, is not limited with respect to resolution or size of an inspection area. A variety of non-destructive examination tools includes, by way of non-limiting example, scanning electron microscopes, atomic force microscopes, optical inspection tools, etc.

It is appreciated that, unless specifically stated otherwise, certain features of the presently disclosed subject matter, which are described in the context of separate embodiments, can also be provided in combination in a single embodiment.

Conversely, various features of the presently disclosed subject matter, which are described in the context of a single embodiment, can also be provided separately, or in any suitable sub-combination. In the following detailed description, numerous specific details are set forth in order to provide a thorough understanding of the methods and apparatus.

In embodiments of the presently disclosed subject matter, fewer, more, and/or different stages than those shown in the methods of FIGS. 3A, 3B, 5, 6A, 6B, 6C, 6D, 7 and 8 may be executed. In embodiments of the presently disclosed subject matter, one or more stages illustrated in the methods of FIGS. 3A, 3B, 5, 6A, 6B, 6C, 6D, 7 and 8 may be executed in a different order, and/or one or more groups of stages may be executed simultaneously.

It will also be understood that the system according to the invention may be, at least partly, implemented on a suitably programmed computer. Likewise, the invention contemplates a computer program being readable by a computer for executing the method of the invention. The invention further contemplates a non-transitory computer-readable memory tangibly embodying a program of instructions executable by the computer for executing the method of the invention.

The invention is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based may readily be utilized as a basis for designing other structures, methods, and systems for carrying out the several purposes of the presently disclosed subject matter.

Those skilled in the art will readily appreciate that various modifications and changes can be applied to the embodiments of the invention as hereinbefore described without departing from its scope, defined in and by the appended claims.

What is claimed is:

1. A system usable to calibrate an examination tool, the examination tool comprising a light source producing an illuminating beam transmitted along a light path, and a plurality of optical devices located on said light path, at least one given optical device of the plurality of optical devices being associated with a given moveable element, at least one of a position or an orientation of the given moveable element having to be calibrated, the system comprising at least one processing circuitry configured to:
obtain a data set comprising values for one or more given parameters characterizing light transmitted by the at least one given optical device for different values of the position or of the orientation of the given moveable element,
obtain one or more required values for the one or more given parameters, and
use the data set and the one or more required values to determine data informative of at least one of a calibrated position or a calibrated orientation of the given moveable element enabling the one or more parameters characterizing light transmitted by the at least one given optical device to have values matching the one or more required values according to a matching criterion.

2. The system of claim 1, configured to use the data set, the one or more required values and a Bayesian optimizer to determine data informative of at least one of a calibrated position or a calibrated orientation of the given moveable element.

3. The system of claim 1, configured to determine the data informative of at least one of a calibrated position or a calibrated orientation of the given moveable element after a plurality of iterations, wherein, the system is configured, for at least one given iteration of the plurality of iterations, to use a data set comprising values for one or more given parameters characterizing light transmitted by the at least one given optical device for one or more positions or one or more orientations of the given moveable element, wherein at least part of said values correspond to one or more positions or one or more orientations of the at least one given optical device, determined at one or more previous iterations of the plurality of iterations.

4. The system of claim 1, configured to determine the data informative of at least one of a calibrated position or a calibrated orientation of the given moveable element after a plurality of iterations, wherein, for at least one given iteration of the plurality of iterations, the system is configured to:
use values for one or more given parameters characterizing light transmitted by the at least one given optical device for different values of the position or of the orientation of the given moveable element to determine data informative of at least one of an updated position or an updated orientation of the given moveable element,
obtain one or more updated values for one or more given parameters characterizing light transmitted by the at least one given optical device at said updated position or at said updated orientation, and
use said one or more updated values at a next iteration of the plurality of iterations.

5. The system of claim 1, configured to feed the data set and the one or more required values to an optimization algorithm to determine data informative of at least one of a calibrated position or a calibrated orientation of the given moveable element, wherein the optimization algorithm is operable to determine the data informative of at least one of a calibrated position or a calibrated orientation of the given moveable element without requiring prior training.

6. The system of claim 1, configured to use the data set, the one or more required values and an optimization algorithm to determine data informative of at least one of a calibrated position or a calibrated orientation of the given moveable element, wherein a cost function used by the optimization algorithm is selected to be convex.

7. The system of claim 1, configured to:
responsive to a failure of determination of data informative of at least one of a calibrated position or a calibrated orientation of the given moveable element enabling the one or more given parameters characterizing light transmitted by the at least one given optical device, to have values matching the one or more required values according to the matching criterion, determine that the at least one given optical device is faulty, or that the examination tool is faulty.

8. The system of claim 1, wherein at least one, or more, of the one or more given parameters is informative of a quality of a light transmitted by the at least one given optical device.

9. The system of claim 1, wherein, after the at least one given optical device has been calibrated at least once using the data set, the system is configured to:
obtain a current uncalibrated position value or a current uncalibrated orientation value of the given moveable element of the at least one given optical device,
obtain one or more required values for the one or more given parameters,
obtain one or more current values for one or more given parameters characterizing light transmitted by the at least one given optical device, and
use the data set, the one or more current values for the one or more given parameters, and at least one of the current uncalibrated position value or the current uncalibrated orientation value to determine data informative of at least one of a calibrated position or a calibrated orientation of the given moveable element, enabling the one or more parameters characterizing light transmitted by the at least one given optical device to have values matching the one or more required values according to a matching criterion.

10. The system of claim 1, wherein the one or more processing circuitries are configured to communicate with the examination tool to obtain the one or more values for the one or more given parameters.

11. The system of claim 1, wherein at least one of (i) or (ii) is met:
(i) the given moveable element is associated with at least one given actuator enabling moving the given moveable element, wherein the at least one processing circuitry is configured to generate a command enabling the at least one given actuator to displace the given moveable element to the calibrated position or to the calibrated orientation;
(ii) the given moveable element is associated with at least one given actuator enabling moving the given moveable element, wherein the at least one processing circuitry implements an interface enabling transmitting the command to the examination tool, wherein the command instructs the at least one given actuator to displace the given moveable element to the calibrated position or to the calibrated orientation.

12. The system of claim 1, wherein:
each given optical device of a set of optical devices of the examination tool is associated with a given moveable element of a set of moveable elements, and
at least one of a position or an orientation of each given moveable element of the set of moveable elements has to be calibrated,
wherein the at least one processing circuitry is configured, for each given optical device of the set optical devices, to:
obtain one or more given values for one or more given parameters characterizing light transmitted by said each given optical device for one or more values of the position or of the orientation of the given moveable element of said each given optical device, thereby obtaining a data set informative of the set of optical devices,
obtain one or more given required values for the one or more given parameters of each given optical device of the set of optical devices, thereby obtaining a set of required values, and
use the data set and the set of required values to determine data informative of at least one of a calibrated position or a calibrated orientation of each given moveable element of the set of moveable elements, enabling the one or more given parameters characterizing light transmitted by each given optical device of the set of optical devices to have values matching the one or more given required values according to a matching criterion.

13. The system of claim 12, wherein at least one of (i) or (ii) is met:
(i) the one or more given parameters characterizing light transmitted by a first given optical device of the set of optical devices is different from at least one of the one or more given parameters characterizing light transmitted by a second given optical device of the set of optical devices;
(ii) the at least one processing circuitry is configured to determine, simultaneously, data informative of at least one of a calibrated position or a calibrated orientation of each given moveable element of the set of moveable elements, enabling the one or more given parameters characterizing light transmitted by each given optical device of the set of optical devices, to have values matching the one or more given required values according to a matching criterion.

14. The system of claim 1, configured to:
obtain a data set including, for each given optical device of one or more optical devices of the examination tool, wherein said each given optical device is associated with a given moveable element, one or more values for one or more given parameters characterizing light transmitted by said each given optical device for one or more values of the position or the orientation of the given moveable element,
obtain one or more given required values for the one or more given parameters of each given optical device, thereby obtaining a set of one or more required values, and
use the data set and the set of one or more required values to determine data informative of at least one of a given updated position or a given updated orientation of the given moveable element of each given optical device of the one or more optical devices.

15. The system of claim 14, configured to:
(1) obtain a set of one or more updated values, wherein the set of one or more updated values comprises, for each given optical device, given updated values for the one or more given parameters characterizing light transmitted by said each given optical device, wherein the given moveable element of said each given optical device of the one or more optical devices complies with said given updated position or with said given updated orientation, thereby enabling augmenting the data set with the set of one or more updated values,
(2) use at least part of the data set and the set of one or more required values to determine data informative of at least one of a given updated position or a given updated orientation of the given moveable element of each given optical device of the one or more optical devices, and
(3) repeat (1) and (2) until the one or more given parameters characterizing light transmitted by said each given optical device of the one or more optical devices have values matching the one or more given required values according to a matching criterion.

16. The system of claim 15, wherein the at least one processing circuitry is configured to send a command to the examination tool to displace the given moveable element of said each given optical device of the one or more optical devices to the updated position or to the updated orientation.

17. The system of claim 15, configured to obtain, for each given optical device, the one or more updated values for the one or more given parameters characterizing light transmitted by said each given optical device, following an input from an operator instructing the given moveable element of said each given optical device of the one or more optical devices to reach the updated position or the updated orientation.

18. A method comprising, for an examination tool comprising a light source producing an illuminating beam transmitted along a light path, and a plurality of optical devices located on said light path, each given optical device of a set of optical devices of the plurality of optical devices being associated with a given moveable element, executing by at least one processing circuitry:
obtaining a set of data comprising a plurality of values for one or more given parameters characterizing light transmitted by each given optical device of the set of optical devices, for a plurality of different values of the position or of the orientation of the given moveable element associated with said each given optical device,
obtaining data informative of a dependency between the optical devices of the set of optical devices, and
using the set of data and the data informative of the dependency to generate a predictive model informative of the set of optical devices, wherein the predictive model is usable for at least one of calibrating or simulating the examination tool.

19. The method of claim 18, comprising using the predictive model to estimate, for a given value of the position or of the orientation of a first given moveable element of a first given optical device of the set of optical devices, one or more predicted values for one or more given parameters characterizing light transmitted by at least one of the first given optical device or by a second given optical device different from the first given optical device.

20. A non-transitory computer readable medium comprising instructions that, when executed by a computer, cause the computer to perform operations enabling calibration of an examination tool, the examination tool comprising a light source producing an illuminating beam transmitted along a light path, and a plurality of optical devices located on said light path, at least one given optical device of the plurality of optical devices being associated with a given moveable element, at least one of a position or an orientation of the given moveable element having to be calibrated, the operations comprising:
obtaining a data set comprising values for one or more given parameters characterizing light transmitted by the at least one given optical device for different values of the position or of the orientation of the given moveable element,
obtaining one or more required values for the one or more given parameters, and
using the data set and the one or more required values to determine data informative of at least one of a calibrated position or a calibrated orientation of the given moveable element, enabling the one or more parameters characterizing light transmitted by the at least one given optical device to have values matching the one or more required values according to a matching criterion.
